(19) United States
(12) Patent Application Publication
(10) Pub. No.: US 2005/0249144 A1
(43) Pub. Date: Nov. 10, 2005

(54) Method of implementing scheduling discipline based on radio resource allocation for variable bandwidth satellite channels

(76) Inventors: Abheek Saha, Haryana (IN); Mohan Rangan, Haryana (IN)

Correspondence Address: NIXON & VANDERHYE, PC, 901 NORTH GLEBE ROAD, 11TH FLOOR, ARLINGTON, VA, 22203, US

(21) Appl. No.: 10/966,106

(22) Filed: Oct. 18, 2004

Related U.S. Application Data
(60) Provisional application No. 60/511,695, filed on Oct. 17, 2003.

(51) Int. Cl. H04B 7/185

(52) U.S. Cl. 370/316; 370/345

(57) ABSTRACT

The present invention is concerned with a method for radio resource allocation for a TDMA wireless radio channel, offering shared bandwidth to multiple connections from multiple end-terminals. The innovation consists of the organization of the radio resource functions, which simultaneously provide a QoS-controlled resource allocation system, and at the same time, optimize the system for best physical capacity.

The present invention is concerned with a method for radio resource allocation for a TDMA wireless radio channel, offering shared bandwidth to multiple connections from multiple end-terminals. The innovation consists of the organization of the radio resource functions, which simultaneously provide a QoS-controlled resource allocation system, and at the same time, optimize the system for best physical capacity.

The underlying physical channel has a TDMA structure. The channel has frames of a given fixed duration and within the frame, multiple transmission units or bursts are defined. The bursts are not necessarily of the same length (in duration), but the total duration has to match the frame duration.

Each channel has a given width and the user terminals may use a variety of bursts of duration and bandwidth such that an integral number of burst durations can add up to the channel frame duration or the channel bandwidth. For example, the channel may be 100 khz wide and have a frame timing of 40 ms, and support bursts which are either 20 ms long or 10 ms long (in duration) and 50 Khz wide or 100 Khz wide (in bandwidth)

The user terminals have differing radio conditions, which means that for a given burst, two different user terminals will be able to transmit different amounts of user data

The burst definition may be such that for a given radio-condition, if we have two bursts so that one is larger than the other (in duration or bandwidth or both), the amount of user data (henceforth called payload) that can be packed on the one is not necessarily proportionately larger than the amount of user data that can be packed on the other, it is either more than the proportional number or less than the proportional number.

There is a requirement to support multiple scheduling disciplines.

The method comprises:

a) The entire resource allocation function is split into four activities. There is a scheduling function, a layout function, a layout service function and a cleanup function.
b) The scheduling function executes an algorithm, which takes as input all pending packets with arrival times and generates a ‘service order’. The algorithm may be chosen to meet the QoS paradigm of the system and the preferences of the operator—various such algorithms are available for use. The output service order is an ordered list of protocol data units to be serviced. The protocol data units that must be serviced in this round are tagged appropriately. Any special service timing requirements for the protocol data units i.e. voice transmission which must happen in low delay are also attached with the protocol data unit.
c) The layout function takes the physical resource and the service order and tries to create an optimal algorithm for the same. The optimal algorithm will
   I) maximize the realized capacity of the physical resource
   II) service protocol data units in the same order in which they are generated
   III) Service all the tagged protocol data units
   IV) honour special timing requirements for any PDUs.
d) The layout algorithm depends on the nature of the physical resource. For an uplink resource, it will involve creation of a transmission time plan. For a downlink FDM system, it will involve composing the frame to be transmitted. For a TDM system, it will involve ordering the protocol data units into bursts.
e) The output of the layout algorithm is the physical resource utilization plan. This plan is serviced by a service function, which interoperates with the
f) It is possible that the service order is generated in advance of the protocol data unit actually becoming available. An example of this is when synchronous voice connection is running, and the arrival of the voice packet for service can be predicted ahead of time. The service order may contain ‘placeholder’ protocol data units. These placeholder data units are specially tagged and are replaced by the actual data unit just in time for the actual service to take place.
g) The cleanup function is executed after the physical resource utilization plan is executed. It reconciles the scheduling function information by updating the original service order by the actual executed list.
h) The resource allocation hierarchy defined here has significant advantages. It allows the QoS function to be insulated from the details of the physical layer interface. It also allows application specific customization for specific applications.

The above description should not be construed as limiting in any manner. Work is still underway in completing the invention. It will be evident that modifications and variations are

1. A method for radio resource allocation for a TDMA wireless radio channel, offering shared bandwidth to multiple connections from multiple end-terminals, the method comprising:
(a) dividing the entire resource allocation function into a scheduling function, a layout function, a layout service function and a cleanup function;
(b) the scheduling function executing an algorithm by taking as input all pending packets with arrival times and generating a service order;
(c) the layout function taking the physical resource and the service order and creating an optimal algorithm therefor;
(d) the output of the layout algorithm consisting of a physical resource utilization plan which is serviced by the layout service function, the two functions being inter-operational,
i) executing a cleanup function after the physical resource utilization plan is executed in order to reconcile the scheduling function information by updating the original service order by the actual executed list.

2. A method as claimed in claim 1 wherein the resource allocation hierarchy allows a QoS function to be insulated from the details of the physical layer interface and also allows application specific customization for specific applications.

3. A method as claimed in claim 1 wherein the algorithm is chosen to meet a QoS paradigm of the system and the preferences of an operator.

4. A method as claimed in claim 1 wherein the output service order is an ordered list of protocol data units to be serviced.

5. A method as claimed in claim 4 wherein the protocol data units that must be serviced are tagged appropriately and wherein any special service timing requirements for the protocol data units such as voice transmission which must happen in low delay are also attached with the protocol data unit.

6. A method as claimed in claim 1 wherein the optimal algorithm functions as follows:
(a) maximizing the realized capacity of the physical resource,
(b) servicing protocol data units in the same order in which they are generated,
(c) servicing all the tagged protocol data units,
(d) honoring special timing requirements for any PDUs.

7. A method as claimed in claim 1 wherein the layout algorithm is dependent on the nature of the physical resource.

8. A method as claimed in claim 7 wherein for an uplink resource, the layout algorithm comprises creation of a transmission time plan.

9. A method as claimed in claim 7 wherein for an downlinlk FDM system, the layout algorithm comprises composing the frame to be transmitted.

10. A method as claimed in claim 7 wherein for a TDM system the layout algorithm comprises ordering the protocol data units into bursts.

11. A method as claimed in claim 1 wherein the service order is generated in advance of the protocol data unit actually becoming available.

12. A method as claimed in claim 11 wherein the protocol data unit running is a synchronous voice connection and the arrival of the voice packet for service is predictable ahead of time.

13. A method as claimed in claim 1 wherein service order contains placeholder protocol data units which are tagged and are replaced by the actual data unit immediately prior to the actual service taking place.
